(19) United States
(12) Patent Application Publication
(10) Pub. No.: US 2021/0397557 A1
(43) Pub. Date: Dec. 23, 2021

(54) METHOD AND APPARATUS WITH ACCELERATOR PROCESSING

(71) Applicants: SAMSUNG ELECTRONICS CO., LTD., Suwon-si (KR); Seoul National University R&DB Foundation, Seoul (KR)

(72) Inventors: Jaejin LEE, Seoul (KR); Heehoon KIM, Seoul (KR); Seung Wook LEE, Suwon-si (KR)

(73) Assignees: SAMSUNG ELECTRONICS CO., LTD., Suwon-si (KR); Seoul National University R&DB Foundation, Seoul (KR)

(21) Appl. No.: 17/148,676

(22) Filed: Jan. 14, 2021

(30) Foreign Application Priority Data
Jun. 22, 2020 (KR) 10-2020-0075655

(51) Int. Cl. G06F 12/0862; G06N 3/08; G06F 12/0842

(52) U.S. Cl. CPC G06F 12/0862; G06F 2212/602; G06F 12/0842; G06N 3/08

(57) ABSTRACT

An accelerator includes processing elements configured to perform an operation associated with an instruction received from a host processor, hierarchical memories configured to be accessible by any one or any combination of any two or more of the processing elements, and sub-cores configured to prefetch data associated with the operation to a memory of a corresponding level of the hierarchical memories.

### CROSS-REFERENCE TO RELATED APPLICATIONS

This application claims the benefit under 35 USC § 119(a) of Korean Patent Application No. 10-2020-0075655 filed on Jun. 22, 2020, in the Korean Intellectual Property Office, the entire disclosure of which is incorporated herein by reference for all purposes.

### BACKGROUND

### 1. Field

The following description relates to a method and apparatus with accelerator processing.

### 2. Description of Related Art

As artificial intelligence (AI) technology progresses, there is a desire for specialized AI hardware that may perform inference and learning through operations. Various devices are being developed as hardware dedicated to the implementation of AI.

Such dedicated hardware for AI may be embodied by, for example, a central processing unit (CPU) and a graphics processing unit (GPU), or by a field-programmable gate array (FPGA) and an application-specific integrated circuit (ASIC) that may be repurposed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an accelerator includes processing elements configured to perform an operation associated with an instruction received from a host processor, hierarchical memories configured to be accessible by any one or any combination of any two or more of the processing elements, and sub-cores configured to prefetch data associated with the operation to a memory of a corresponding level of the hierarchical memories.

The sub-cores may further perform the prefetching based on a data access portion for the operation in the instruction.

The sub-cores may further perform the prefetching independent of the processing elements.

The processing elements may further perform the operation associated with the instruction using the data prefetched to the hierarchical memories by the sub-cores.

The sub-cores may cooperatively prefetch the data associated with the operation based on a structure of the hierarchical memories.

The hierarchical memories may include any one or any combination of any two or more of a level 0 memory accessible by one of the processing elements, a level 1 memory accessible by a portion of the processing elements, and a level 2 memory accessible by the processing elements.

The sub-cores may prefetch the data associated with the operation based on differing access costs differing for levels of the hierarchical memories.

An access cost for each of the hierarchical memories may increase as the number of processing elements sharing a corresponding one of the hierarchical memories increases.

The accelerator may be included in a user terminal to which data to be recognized through a neural network corresponding to the instruction is input, or a server configured to receive the data to be recognized from the user terminal.

The prefetching performed by the sub-cores may be performed by cooperation of the sub-cores based on usage information of hardware resources of the accelerator.

The usage information of the hardware resources may include usage information of an operation resource based on the processing elements, and usage information of a memory access resource based on either one or both of the hierarchical memories in the accelerator and an off-chip memory of the accelerator.

In another general aspect, a method of operating an accelerator includes receiving an instruction for performing an operation from a host processor, reading, from hierarchical memories, data targeted for the operation associated with the instruction, and performing the operation associated with the instruction based on the data. The data may be prefetched by sub-cores respectively corresponding to the hierarchical memories based on a data access portion for the operation in the instruction.

The sub-cores may be configured to independently perform prefetching from processing elements in the accelerator.

The sub-cores may be configured to cooperatively prefetch the data associated with the operation based on a structure of the hierarchical memories.

The hierarchical memories may include any one or any combination of any two or more of a level 0 memory accessible by one of a plurality of processing elements in the accelerator, a level 1 memory accessible by a portion of the processing elements; and a level 2 memory accessible by the processing elements.

The sub-cores may be configured to prefetch the data associated with the operation based on differing access costs for levels of the hierarchical memories.

An access cost for each of the hierarchical memories may increase as a number of processing elements sharing a corresponding one of the hierarchical memories increases.

A non-transitory computer-readable storage medium may store instructions that, when executed by one or more processors, configure the one or more processors to perform the method above.

In still another general aspect, an accelerator system includes a host processor configured to transmit an instruction to an accelerator, and the accelerator including processing elements configured to perform an operation associated with the instruction, hierarchical memories configured to be accessible by any one or any combination of any two or more of the processing elements, and sub-cores configured to prefetch data associated with the operation to a memory of a corresponding level of the hierarchical memories. The sub-cores may control a prefetching operation based on a data access portion for the operation in the instruction.

The sub-cores may be further configured to perform the prefetching operation independent of the processing elements.

Other features and aspects will be apparent from the following detailed description, the drawings, and the claims.

### BRIEF DESCRIPTION OF THE DRAWINGS

FIG. 1 is a diagram illustrating an example of an accelerator system.

FIGS. 2 and 3 are diagrams illustrating an example of a hierarchical structure of an accelerator.

FIG. 4 is a diagram illustrating an example of a prefetching operation.

FIG. 5 is a flowchart illustrating an example of a method of operating an accelerator.

FIGS. 6 and 7 are diagrams illustrating examples of an accelerator system.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in the examples described herein may also be referred to as a second member, component, region, layer, or section without departing from the teachings of the examples.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween. Likewise, similar expressions, for example, “between” and “immediately between,” and “adjacent to” and “immediately adjacent to,” are also to be construed in the same way. As used herein, the term “and/or” includes any one and any combination of any two or more of the associated listed items.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Also, in the description of example embodiments, detailed description of structures or functions that are thereby known after an understanding of the disclosure of the present application will be omitted when it is deemed that such description will cause ambiguous interpretation of the example embodiments. Hereinafter, examples will be described in detail with reference to the accompanying drawings, and like reference numerals in the drawings refer to like elements throughout.

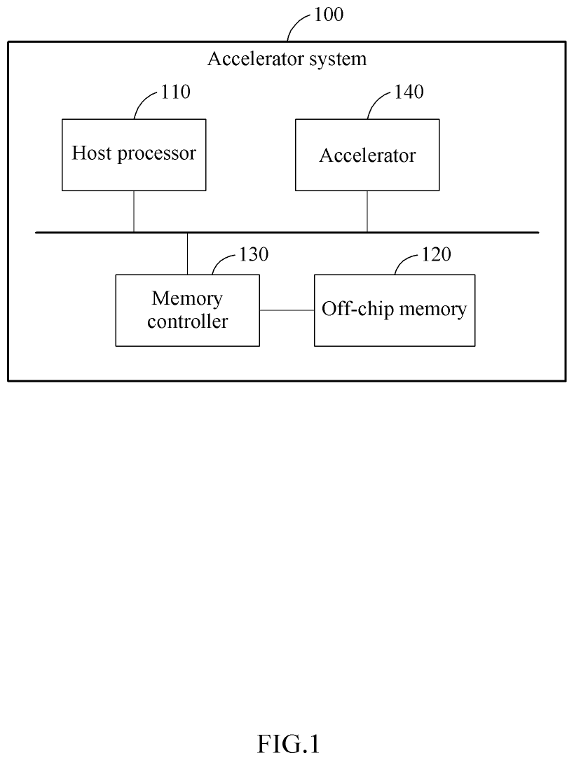

FIG. 1 is a diagram illustrating an example of an accelerator system.

In FIG. 1, an accelerator system 100 may include a host processor 110, an off-chip memory 120, a memory controller 130, and an accelerator 140. The host processor 110, the off-chip memory 120, the memory controller 130, and the accelerator 140 may communicate with one another through a bus.

The host processor 110 may be a device configured to control respective operations of components included in the accelerator system 100 and may include a central processing unit (CPU), for example. In an example, the host processor 110 may receive a request for processing a neural network-based inference task in the accelerator 140, and transmit an instruction to the accelerator 140 in response to the received request. The request may be made for neural network-based data inference, and for obtaining a result of the data inference by allowing the accelerator 140 to execute a neural network for speech recognition, machine translation, machine interpretation, object recognition, pattern recognition, computer vision, or the like.

The off-chip memory 120 may be a memory disposed outside the accelerator 140, and be a dynamic random-access memory (DRAM) used as a main memory of the accelerator system 100. The off-chip memory 120 may be accessible through the memory controller 130. The off-chip memory 120 may store at least one of instructions to be executed in the accelerator 140, parameters of the neural network, or input data to be inferred, and be used in an example in which an on-chip memory in the accelerator 140 is not sufficient to execute the neural network in the accelerator 140.

The off-chip memory 120 may have a larger memory capacity than the on-chip memory in the accelerator 140. However, when executing the neural network, a cost for access by the accelerator 140 to the off-chip memory 120 may be greater than a cost for access to the on-chip memory. Such a memory access cost may indicate an amount of power and/or processing time that is required for accessing a memory and then reading or writing data from or in the memory.

The accelerator 140 may be an artificial intelligence (AI) accelerator configured to execute the neural network based on the instruction of the host processor 110 and infer data to be input, and be a separate processor distinguished from the host processor 110. The accelerator 140 may be embodied as a neural processing unit (NPU), a graphics processing unit (GPU), a tensor processing unit (TPU), a CPU, or the like.

The neural network may include a plurality of layers. In an example, the neural network may include an input layer, a plurality of hidden layers, and an output layer. Each of the layers may include a plurality of nodes each referred to as an artificial neuron. Each of the nodes may indicate a computation unit having at least one input and output, and the nodes may be connected to one another. A weight may be set for a connection between nodes, and be adjusted or changed. The weight may be a parameter that determines the influence of a related data value on a final result by increasing, decreasing, or maintaining the data value. To each node included in the output layer, weighted inputs of nodes included in a previous layer may be input. A process in which weighted data is input from a layer to a subsequent layer of the layer may be referred to as propagation.

The accelerator 140 may process a task or workload that is more effectively processed by a separate dedicated processor, for example, the accelerator 140, than by the host processor 110 used for general computing purposes, based on the characteristics of operations of the neural network. Here, one or more processing elements (PEs) included in the accelerator 140, and the on-chip memory may be used. A PE may be a device configured to perform an operation or computation associated with a received instruction, and include an operation unit, for example, a streaming multiprocessor (SM), a floating-point unit (FPU), or the like. The on-chip memory may be a device including a global shared buffer and a local buffer that are included in the accelerator 140, and be distinguished from the off-chip memory 120 disposed outside the accelerator 140. The on-chip memory may include, for example, a static random-access memory (SRAM), as a scratchpad memory accessible through an address space.

The scratchpad memory may be a high-speed low-capacity memory that is explicitly controlled. The scratchpad memory may be similar to an L1 cache of a CPU in terms of high speed and low capacity, but be different in terms of how it operates. For example, when a request for data movement is received, the cache may perform tag comparison to verify whether data is already loaded or not, and then respond to the request by performing the data movement based on a result of the tag comparison. However, in an example of the scratchpad memory, a program may explicitly instruct the data movement, and a response to the request may be immediately performed without an additional process. Thus, the scratchpad memory may not require hardware for tag storage and comparison, or the like, and thus efficiency in terms of energy and hardware area size may be greater than that in the cache. When the data movement is effectively specified, a high level of performance may be obtained even for a data access pattern lacking locality. The scratchpad memory may be used in combination with the cache memory, as needed.

Prefetching may be performed to fetch, in advance, data predicted to be used in the imminent future from a lower-level memory to an upper-level memory, thereby reducing memory access latency and improving system performance. For example, through the prefetching, a request that is to occur in the imminent future may be predicted in the scratchpad memory, and data movement may be performed in advance. In an example of the cache memory, the data movement may be dependent on a request, and thus the predicted request may be performed in advance to generate the data movement in advance, and then when the request is received, a response may be generated immediately without the data movement. In addition, in an example of supporting data movement without a request, for example, a x86 prefetch instruction, the prefetching may be applied in a similar way as in the scratchpad memory.

By applying such a prefetching method to an operation of the accelerator 140, it is possible to effectively improve the performance of the accelerator 140. This will be described in detail hereinafter with reference to the accompanying drawings.

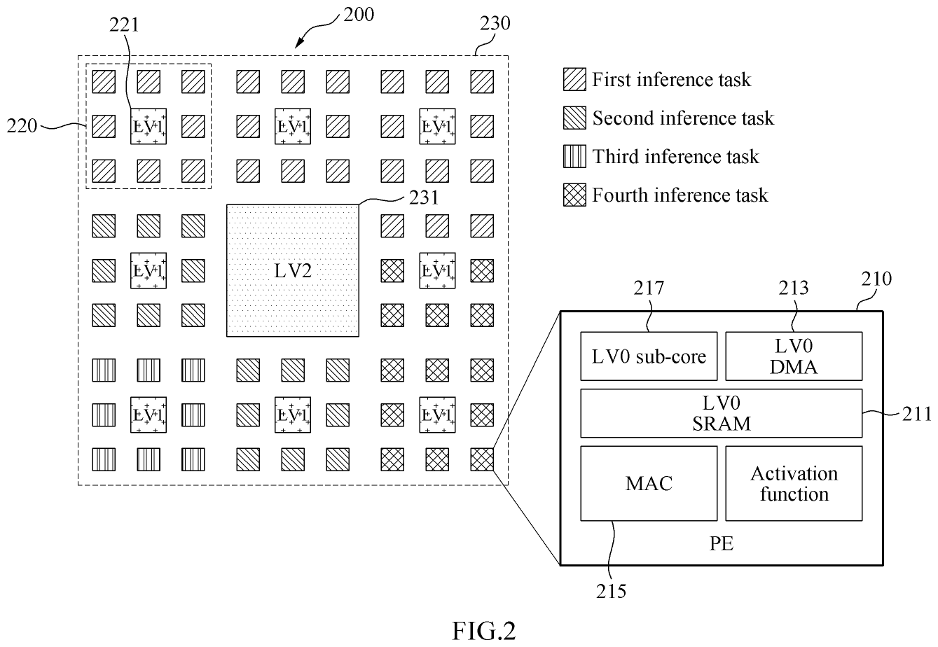

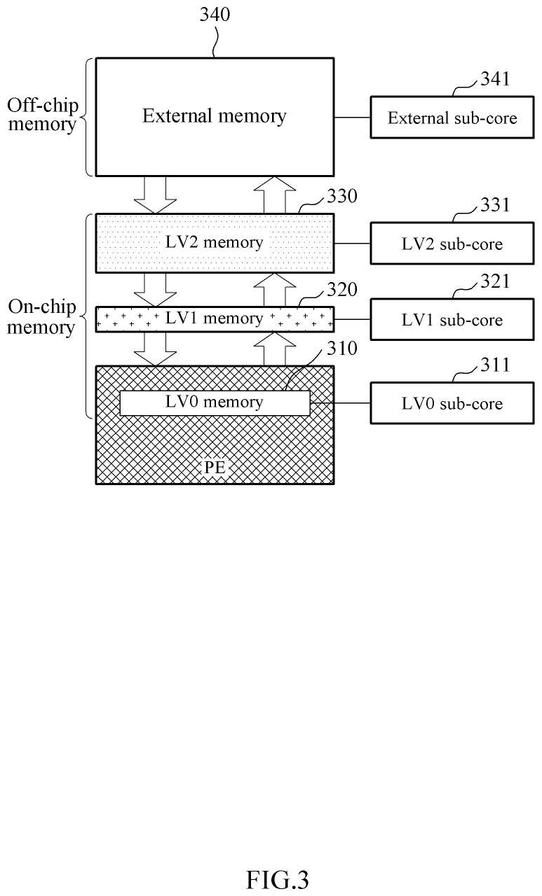

FIGS. 2 and 3 are diagrams illustrating an example of a hierarchical structure of an accelerator.

In FIG. 2, an accelerator 200 may include a plurality of PEs and hierarchical memories accessible by at least one of the PEs. The hierarchical memories include a level (LV) 0 memory 211, an LV1 memory 221, and an LV2 memory 231.

A PE 210 of the PEs may include an LV 0 memory 211, an LV 0 direct memory access (DMA) 213, a multiplier-accumulator (MAC) 215, and an LV 0 sub-core 217. The PE 210 may be a main core of the accelerator 200.

The LV 0 memory 211 may be a memory accessible by the corresponding PE 210. That is, the LV 0 memory 211 may be accessible only by one of the PEs included in the accelerator 200, for example, the PE 210.

The LV0 DMA 213 may control input data and/or output data of the LV0 memory 211 based on an instruction from the LV0 sub-core 217. The LV0 DMA 213 may read data from the LV0 memory 211 or write data in the LV0 memory 211 based on information associated with a source, a destination, and a data size that is included in the instruction from the LV0 sub-core 217.

The data input to the LV 0 memory 211 or the data output from LV 0 memory 211 may be monitored and/or profiled. Such monitoring and/or profiling may be performed in the LV0 DMA 213 or a separate element. Through the monitoring and/or profiling, it is possible to verify an access cost of the LV 0 memory 211, usage information of the LV 0 memory 211, and a type of data stored in the LV0 memory 211. For example, the LV0 DMA 213 may verify what percentage is indicated as the usage information of the LV0 memory 211, and which inference task is associated with the data stored in the LV0 memory 211. Hereinafter, for the convenience of description, examples will be described based on an example in which such a monitoring and/or profiling operation is performed in the LV0 DMA 213.

The MAC 215 may perform an operation or computation of an inference task assigned to the PE 210. For example, the MAC 215 may perform a multiply-accumulate operation on a given data. In this example, the MAC 215 may apply an activation function to the given data. The activation function may be sigmoid, hyperbolic tangent (tan h), or a rectified linear unit (ReLU), for example.

The LV0 sub-core 217 may be a device configured to control components included in the PE 210. For example, the LV0 sub-core 217 may control the LV0 memory 211, the LV0 DMA 213, and the MAC 215.

The foregoing description of the PE 120 may be applied to each of the PEs included in the accelerator 200. That is, the accelerator 200 may include the PEs each performing an operation or computation independently.

In an example, each n PEs of the PEs included in the accelerator 200 may cluster together. In this example, n is a natural number greater than 1 and less than the number of the PEs included in the accelerator 200. That is, a portion of the PEs included in the accelerator 200 may cluster together to form a cluster, for example, a PE cluster 220.

PEs included in the cluster 220 may share one LV1 memory 221. That is, the LV1 memory 221 may be accessible by the PEs included in the cluster 220. For example, even though operations respectively performed in a first PE and a second PE of the PEs in the cluster 220 are different from each other, a portion of data required for the operations may be common. As the common data is stored in the LV1 memory 221, rather than it is stored in an LV0 memory 211 included in each of the first PE and the second PE, and the first PE and the second PE may share the common data, and thus an overall system operation efficiency may be improved. In the example of FIG. 2, each of the PEs may access an LV1 memory 221 adjacent to each of the PEs.

In another example of FIG. 2, there is an LV1 DMA configured to monitor and/or profile data input to or output from the LV1 memory 221. In addition, there is also an LV1 sub-core to control the LV1 memory 221 and the LV1 DMA.

In addition, an entirety 230 of the PEs may share the LV2 memory 231. That is, the LV2 memory 231 may be accessible by all the PEs included in accelerator 200. For example, there may be PEs that share a portion of data required to perform an operation, although not clustering together to form a same cluster, of the PEs included in the accelerator 200. In this example, such PEs may not share the data through the LV1 memory 221, but effectively share the common data through the LV2 memory 231, thereby increasing the overall operation efficiency. In another example of FIG. 2, there is an LV2 DMA configured to monitor and/or profile data input to or output from the LV2 memory 231. In addition, there is also an LV2 sub-core to control the LV2 memory 231 and the LV2 DMA.

As described above, each of the PEs may access a respective LV0 memory 211, an LV1 memory 221 adjacent to each of the PEs, and an LV2 memory 231 of the accelerator 200, and use these memories to perform an assigned inference task. The accelerator 200 may include such hierarchical memories. An LV0 memory, an LV1 memory, and an LV2 memory may be a scratchpad memory having an access cost less than that of a dynamic random-access memory (DRAM) which is an external memory.

In addition, sub-cores and DMAs included in the accelerator 200 may be provided in a hierarchical structure.

In the example of FIG. 2, the PEs included in the accelerator 200 may simultaneously perform four inference tasks. For example, an inference task with a relatively greater operation amount may be assigned to a greater number of PEs and processed therein, and an inference task with a relatively less operation amount may be assigned to a smaller number of PEs and processed therein.

It is illustrated in FIG. 2 that each eight PEs of 64 PEs cluster together to form eight clusters, and three level memories are used to perform the four inference tasks, for the convenience of description. However, various numbers of PEs, inference tasks, and levels may be applied without limitation. A sub-core described herein may be a general processor that operates based on an additional instruction for performing prefetching on hierarchical memories. The sub-core may also be referred to herein as a helper core (HC) for the convenience of description.

FIG. 3 illustrates an example of a hierarchical structure of an LV0 memory 310, an LV1 memory 320, an LV2 memory 330, and an external memory 340.

The LV0 memory 310, the LV1 memory 320, and the LV2 memory 330 may be disposed as an on-chip memory in an accelerator. The LV2 memory 330 may be a memory shared by a plurality of PEs included in the accelerator, and the LV1 memory 320 may be a memory shared by some of the PEs. The LV0 memory 310 may be included in each of the PEs and not be shared with another PE. In the accelerator, there are the LV0 memory 310 provided in number corresponding to the number of the PEs included in the accelerator, the LV1 memory 320 provided in number corresponding to the number of clusters of the PEs, and the LV2 memory 330 may be provided as only one or in number less than the number of the LV1 memory 320 based on a structure of the accelerator.

The external memory 340 may be an off-chip memory disposed outside the accelerator and include, for example, a DRAM, a three-dimensional (3D) memory such as a high bandwidth memory (HBM), and a processing in memory (PIM). The external memory 340 may also be referred to herein as an LV3 memory for the convenience of description.

The LV0 memory 310, the LV1 memory 320, the LV2 memory 330, and the external memory 340 may be used when a PE performs an inference task, and a memory access cost may differ for each level. For example, the memory access cost may increase as the level increases. That is, an access cost of the LV0 memory 310 may be the lowest, and an access cost of the external memory 340 may be the highest.

Such hierarchical memories may store prefetched data in association with an operation performed in a PE. Here, a prefetching operation may be performed in sub-cores 311, 321, 331, and 341 respectively corresponding to the hierarchical memories. When a PE performs an operation associated with an instruction, the sub-cores 311, 321, 331, and 341 may move data needed for the operation from the external memory 340 to a memory disposed adjacent to the PE, and thus minimize a memory access cost for actually performing the operation. That is, the sub-sores 311, 321, 331, and 341 may prefetch the data in cooperation with one another to minimize a memory access cost for loading the data associated with the operation by the PE.

In addition, such a prefetching operation may be performed by the sub-cores 311, 321, 331, and 341 in cooperation with one another based on a situation of hardware resources of the accelerator. The hardware resources may include an operation resource based the PEs included in the accelerator, and a memory access resource based on the on-chip memory and/or the off-chip memory of the accelerator. For example, when an available capacity of the LV0 memory 311 is insufficient, data associated with an operation to be performed in a PE may be prefetched to the LV1 memory 320 with a second least memory access cost.

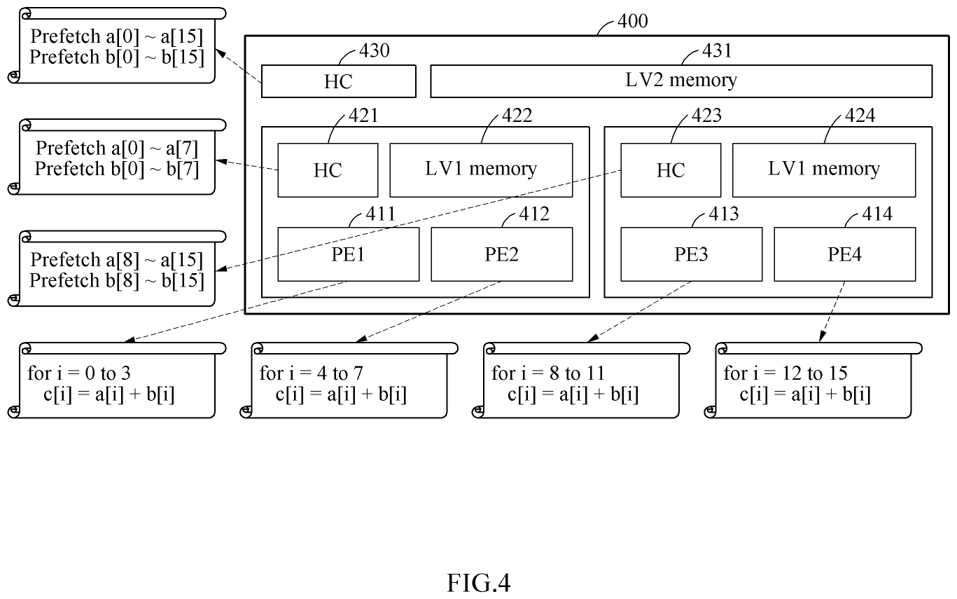

FIG. 4 is a diagram illustrating an example of a prefetching operation.

An example where a vector addition operation is performed in an accelerator 400 is illustrated to describe a prefetching operation.

In FIG. 4, the vector addition operation may be performed in a plurality of PEs 411, 412, 413, and 414. A memory of each level may include a cache memory and a scratchpad memory, and support reading/writing with a memory of another level and prefetching to a lower-level memory. A prefetch instruction that predicts a memory to be used at each level may be generated based on an instruction to be executed in the PEs 411, 412, 413, and 414, and sub-cores 421, 423, and 430 may perform a prefetching operation based on the prefetch instruction.

In the example of FIG. 4, it is assumed that the four PEs 411, 412, 413, and 414 perform, in parts, an addition operation of vectors with a length of 16 by dividing the operation. The prefetch instruction for the sub-cores 421, 423, and 430 may be determined based on a data access portion of a vector operation instruction for each of the PEs 411, 412, 413, and 414. For example, the LV2 sub-core 430 may prefetch, to an LV2 memory 431, data a[0]-a[15] and b[0]-b[15] to be used in the PEs 411, 412, 413, and 414. The LV1 sub-core 421 may prefetch, to an LV1 memory 422, data a[0]-a[7] and b[0]-b[7] to be used in PE 1 411 and PE2 412. The LV1 sub-core 423 may prefetch, to an LV1 memory 424, data a[8]-a[15] and b[8]-b[15] to be used in PE3 413 and PE4 414. In another example of FIG. 4, an LV0 sub-core corresponding to each of the PEs 411, 412, 413, and 414 may prefetch, to a corresponding LV0 memory, data to be used in a corresponding PE. In addition, the PEs 411, 412, 413, and 414 may rapidly access a corresponding LV1 memory for data needed for the addition operation and perform the assigned vector operation.

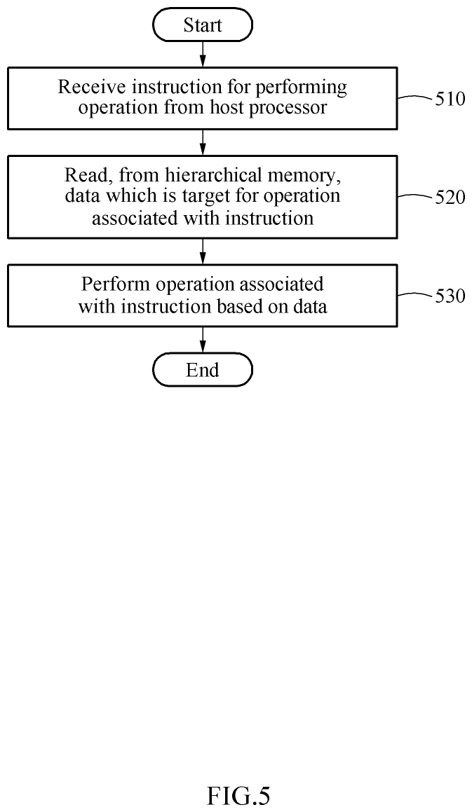

FIG. 5 is a flowchart illustrating an example of a method of operating an accelerator.

Hereinafter, an operation method of an accelerator will be described with reference to FIG. 5.

In operation 510, the accelerator receives an instruction for performing an operation from a host processor.

In operation 520, the accelerator reads, from hierarchical memories, data which is a target for the operation associated with the instruction. The data may be prefetched by sub-cores respectively corresponding to the hierarchical memories based on a data access portion for the operation in the instruction. The sub-cores may perform such a prefetching operation independently from a plurality of PEs. The sub-cores may prefetch the data associated with the operation in cooperation with one another based on a structure the hierarchical memories.

In an example, the hierarchical memories may include at least one of an LV0 memory accessibly by one of the PEs, an LV1 memory accessible by a portion of the PEs, or an LV2 memory accessible by the PEs. The sub-cores may prefetch the data associated with the operation based on access costs of the hierarchical memories that differ based on a level of the hierarchical memories. An access cost of a memory of the hierarchical memories may increase as the memory has a greater number of PEs sharing the memory.

In operation 530, the accelerator performs the operation associated with the instruction based on the data.

Through the operation method described above with reference to FIG. 5, it is possible to reduce a memory loading time for the execution of an inference task, and improve system performance by off-loading, into a sub-core, a workload of PEs corresponding to a main core. In an example of a deep learning model, in a main operation or computation, a memory access pattern of a main core may not be dependent on input data, and it is thus possible to readily generate an instruction for a sub-core and utilize it.

For a more detailed description of the operations described above with reference to FIG. 5, reference may be made to what has been described above with reference to FIGS. 1 through 4, and thus a more detailed and repeated description will be omitted here for brevity.

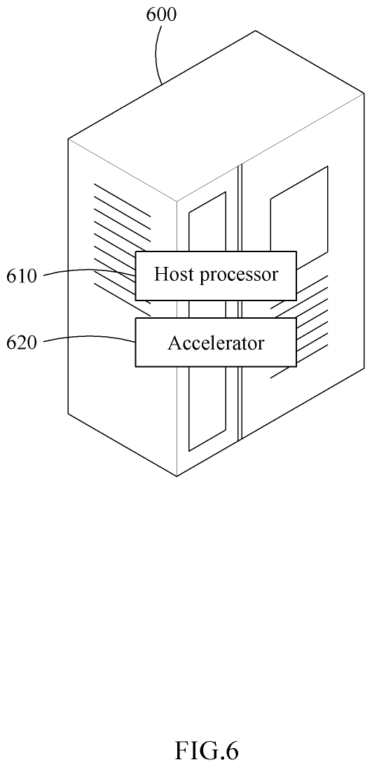

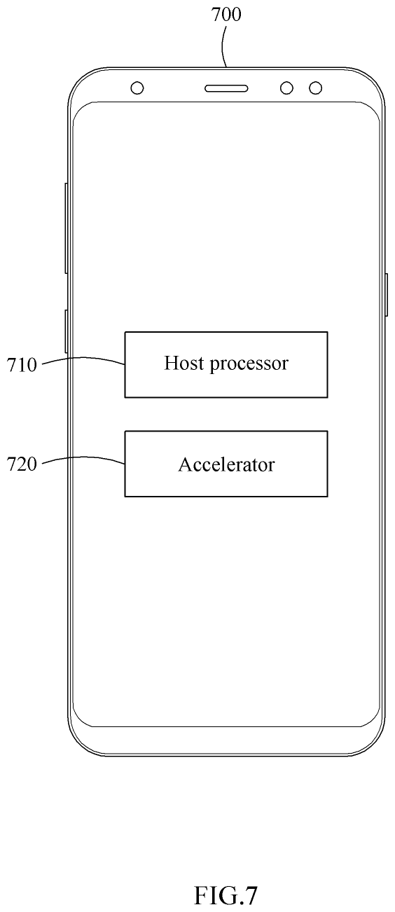

FIGS. 6 and 7 are diagrams illustrating examples of an accelerator system.

In FIG. 6, an accelerator system may be embodied as a server 600. The server 600 may refer to a separate device distinguished from a user terminal controlled by a user, and may communicate with one or more user terminals through a wired and/or wireless network. The server 600 may receive requests that are simultaneously transmitted from multiple users through their user terminals. To perform an inference task in response to a request, an accelerator 620 may perform an operation or computation associated with an instruction transmitted from a host processor 610. The accelerator 620 may include a plurality of PEs that perform the operation, hierarchical memories accessible by at least one of the PEs, and sub-cores that prefetch data associated with the operation to a memory of a corresponding level. The server 600 may return an inference result generated through the inference task to a user terminal. The user terminal described herein may include, for example, a computing device such as a smartphone, a personal computer (PC), a tablet PC, and a laptop, a wearable device such as a smart watch and smart eyeglasses, a home appliance such as a smart speaker, a smart TV, and a smart refrigerator, and other devices such as a smart vehicle, a smart kiosk, and an Internet of things (loT) device.

In FIG. 7, an accelerator system may be embodied as a user terminal 700. Although the user terminal 700 is illustrated as a smartphone in FIG. 7 for the convenience of description, any device that is controlled by a user may be applicable without limitation. The user terminal 700 may obtain a request directly from a user, and an accelerator 720 may perform an operation or computation associated with an instruction transmitted from a host processor 710 based on data prefetched to hierarchical memories.

The accelerator, the accelerator system, accelerator system 100, host processor 110, 610, 710, off-chip memory 120, memory controller 130, accelerator 140, accelerator 200, 620, 720, PE 210, level (LV) 0 memory 211, 310, LV1 memory 221, 320, LV2 memory 231, 330, LV 0 direct memory access (DMA) 213, multiplier-accumulator (MAC) 215, LV 0 sub-core 217, external memory 340, sub-cores 311, 321, 331, 341, server 600, user terminal 700, and other apparatuses, units, modules, devices, and other components described herein with respect to FIGS. 1, 2, 3, 6, and 7 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-7 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An accelerator comprising:
processing elements configured to perform an operation associated with an instruction received from a host processor;
hierarchical memories configured to be accessible by any one or any combination of any two or more of the processing elements; and
sub-cores configured to prefetch data associated with the operation to a memory of a corresponding level of the hierarchical memories.

2. The accelerator of claim 1, wherein the sub-cores are further configured to:
perform the prefetching based on a data access portion for the operation in the instruction.

3. The accelerator of claim 1, wherein the sub-cores are further configured to:
perform the prefetching independent of the processing elements.

4. The accelerator of claim 1, wherein the processing elements are further configured to:
perform the operation associated with the instruction using the data prefetched to the hierarchical memories by the sub-cores.

5. The accelerator of claim 1, wherein the sub-cores are further configured to:
cooperatively prefetch the data associated with the operation based on a structure of the hierarchical memories.

6. The accelerator of claim 1, wherein the hierarchical memories comprise any one or any combination of any two or more of:
a level 0 memory accessible by one of the processing elements;
a level 1 memory accessible by a portion of the processing elements; and
a level 2 memory accessible by the processing elements.

7. The accelerator of claim 6, wherein the sub-cores are further configured to:
prefetch the data associated with the operation based on differing access costs for levels of the hierarchical memories.

8. The accelerator of claim 6, wherein an access cost for each of the hierarchical memories increases as a number of processing elements sharing a corresponding one of the hierarchical memories increases.

9. The accelerator of claim 1, being comprised in a user terminal to which data to be recognized through a neural network corresponding to the instruction is input, or a server configured to receive the data to be recognized from the user terminal.

10. The accelerator of claim 1, wherein the prefetching performed by the sub-cores are performed by cooperation of the sub-cores based on usage information of hardware resources of the accelerator.

11. The accelerator of claim 10, wherein the usage information of the hardware resources includes usage information of an operation resource based on the processing elements, and usage information of a memory access resource based on either one or both of the hierarchical memories in the accelerator and an off-chip memory of the accelerator.

12. A method of operating an accelerator, comprising:
receiving an instruction for performing an operation from a host processor;
reading, from hierarchical memories, data targeted for the operation associated with the instruction; and
performing the operation associated with the instruction based on the data,
wherein the data is prefetched by sub-cores respectively corresponding to the hierarchical memories based on a data access portion for the operation in the instruction.

13. The method of claim 12, wherein the sub-cores are configured to independently perform prefetching from processing elements in the accelerator.

14. The method of claim 12, wherein the sub-cores are configured to cooperatively prefetch the data associated with the operation based on a structure of the hierarchical memories.

15. The method of claim 12, wherein the hierarchical memories comprise any one or any combination of any two or more of:
a level 0 memory accessible by one of a plurality of processing elements in the accelerator;
a level 1 memory accessible by a portion of the processing elements; and
a level 2 memory accessible by the processing elements.

16. The method of claim 15, wherein the sub-cores are configured to prefetch the data associated with the operation based on differing access costs for levels of the hierarchical memories.

17. The method of claim 15, wherein an access cost for each of the hierarchical memories increases as a number of processing elements sharing a corresponding one of the hierarchical memories increases.

18. A non-transitory computer-readable storage medium storing instructions that, when executed by one or more processors, configure the one or more processors to perform the method of claim 12.

19. An accelerator system comprising:
a host processor configured to transmit an instruction to an accelerator, the accelerator comprising:
processing elements configured to perform an operation associated with the instruction;
hierarchical memories configured to be accessible by any one or any combination of any two or more of the processing elements; and
sub-cores configured to prefetch data associated with the operation to a memory of a corresponding level of the hierarchical memories, and control a prefetching operation based on a data access portion for the operation in the instruction.

20. The accelerator system of claim 19, wherein the sub-cores are further configured to perform the prefetching operation independent of the processing elements.
